(19) United States
(12) Patent Application Publication
(10) Pub. No.: US 2026/0099273 A1
(43) Pub. Date: Apr. 9, 2026

(54) MANAGING PROGRAM EXECUTION IN A COMPUTATIONAL STORAGE DEVICE

(71) Applicant: Yangtze Memory Technologies Co., Ltd., Wuhan (CN)

(72) Inventor: Tianyi WANG, Wuhan (CN)

(21) Appl. No.: 18/953,014

(22) Filed: Nov. 19, 2024

Related U.S. Application Data
(63) Continuation of application No. PCT/CN2024/123622, filed on Oct. 9, 2024.

(51) Int. Cl. G06F 3/06

(52) U.S. Cl. CPC G06F 3/0659; G06F 3/0604; G06F 3/0656; G06F 3/0679

(57) ABSTRACT

Methods, systems, and computational storage device of executing an execute program command is presented. In one aspect, the system includes a host. The host is configured to send an execute program command, where the execute program command indicates one or multiple programs and an order of executing the multiple programs when the multiple programs are indicated. The system also includes a computational storage device. The computational storage device is configured to receive the execute program command from the host; and in response to determining that the execute program command indicates multiple programs, execute the multiple programs according to the order of executing the multiple programs.

### CROSS-REFERENCE TO RELATED APPLICATIONS

This application is a continuation of International Application No. PCT/CN2024/123622, filed on Oct. 9, 2024, the disclosure of which is hereby incorporated by reference in its entirety.

### TECHNICAL FIELD

The present disclosure generally relates to managing program execution in a computational storage device.

### BACKGROUND

A computational storage device can include one or more memory devices and a controller that manages the data stored in the one or more memory devices and communicates with a host follows a non-volatile memory express (NVMe) command set. Various operations can be performed by the memory device based on the different commands sent from the host.

### SUMMARY

The present disclosure provides methods, systems, and computational storage device for execute multiple programs.

One aspect of the present disclosure features a system. The system includes a host configured to send an execute program command, where the execute program command indicates one or multiple programs and an order of executing the multiple programs when the multiple programs are indicated. The system also includes a computational storage device configured to receive the execute program command from the host; and in response to determining that the execute program command indicates multiple programs, execute the multiple programs according to the order of executing the multiple programs.

In some implementations, the computational storage device is further configured to send a command status to the host after completion of execution of the multiple programs, where the command status is a success status corresponding to the execution of the multiple programs being successful or a failed status corresponding to the execution of the multiple programs being failed, where the failed status includes one or more indices corresponding to one or more of the multiple programs being failed.

In some implementations, the execute program command includes a flag indicating whether one or multiple programs are to be executed.

In some implementations, the order of executing the multiple programs is indicated by a mapping table included in the execute program command or stored in a data buffer.

In some implementations, the mapping table is stored in the data buffer, the execute program command further includes a data pointer identifying an address of the mapping table in the data buffer.

In some implementations, the mapping table includes program indexes of the multiple programs to be executed by the computational storage device, operation indicators identifying memory range sets of the multiple programs within the computational storage device, and parameters identifying an address of input and output parameters in the memory range sets.

In some implementations, the order of executing the multiple programs is sequential, parallel, or a combination of sequential and parallel.

In some implementations, the computational storage device includes a controller, and where the controller is configured to receive and parsing the execute program command.

In some implementations, the computational storage device further includes: a compute namespace, where the compute namespace is configured to execute the multiple programs based on the parsed execute program command; a first memory namespace, where the first memory namespace input and output parameters for the multiple programs; and a second memory namespace, where the second memory namespace includes memory data.

In some implementations, execute the multiple programs including: executing the multiple programs on the compute namespace based on the memory range sets according to the order of executing the multiple programs.

Another aspect of the present disclosure features a method of execute a execute program command. The method includes receiving and parsing an execute program command from a host, where the execute program command indicates one or multiple programs to be executed by a computational storage device and an order of executing the multiple programs when the multiple programs are indicated; and in response to determining that the execute program command indicates multiple programs, executing the multiple programs according to the order of executing the multiple programs.

In some implementations, the computational storage device is further configured to send a command status to the host after completion of execution of the multiple programs where the command status is a success status corresponding to the execution of the multiple programs being successful or a failed status corresponding to the execution of the multiple programs being failed, where the failed status includes one or more indices corresponding to one or more of the multiple programs being failed.

In some implementations, the method further includes: verifying a value of a flag of the execute program command, where the flag indicates whether one or multiple programs are to be executed.

In some implementations, the order of executing the multiple programs is indicated by a mapping table included in the execute program command or stored in a data buffer.

In some implementations, the order of executing the multiple programs can be either directly indicated by the execute program command or indirectly indicated by the execute program command as well as a data buffer associated with the execute program command.

In some implementations, the mapping table is stored in the data buffer and the method further includes: identifying an address of the mapping table in the data buffer with a data pointer in the execute program command; and locating the mapping table in the data buffer based on the address.

In some implementations, the mapping table includes program indexes of the multiple programs to be executed by the computational storage device, operation indicators identifying memory range sets of the multiple programs within the computational storage device, and additional parameters identifying an address of input and output parameters in the memory range sets.

In some implementations, the order of executing the multiple programs is sequential, parallel, or a combination of sequential and parallel.

In some implementations, the computational storage device includes:
a controller, and where the controller is configured to receive and parse the execute program command; a compute namespace includes computational resources configured to execute the multiple programs based on the parsed execute program command; a first memory namespace, where the first memory namespace stores input and output parameters for the multiple programs ; and a second memory namespace, where the second memory namespace includes memory data.

In some implementations, execute the multiple programs including: executing the multiple programs on the compute namespace based on the memory range sets according to the order of executing the multiple programs.

A further aspect of the present disclosure features a computational storage device. The computational storage device includes computational resources; and a controller coupled to the computational resources and configured to control the computational resources; where the controller is configured to receive and parse an execute program command from a host, where the execute program command indicates one or multiple programs and an order of executing the multiple programs when the multiple programs are indicated, and where the computational resources are configured to in response to determining that the execute program command indicates multiple programs, execute the multiple programs according to the order of executing the multiple programs.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A-1B illustrate a block diagram of an example system having a memory device.

FIG. 1C illustrates a block diagram of an example host.

FIG. 2 illustrates a schematic diagram of an example memory device including peripheral circuits, according to some aspects of the present disclosure.

FIG. 3 illustrates some example peripheral circuits, according to some aspects of the present disclosure.

FIG. 4A illustrates a diagram of an example process 400 of executing a command, according to some aspects of the present disclosure.

FIG. 4B illustrates an example mapping table according to some aspects of the present disclosure.

FIG. 4C illustrates an example order of operation of an execute program command according to some aspects of the present disclosure.

FIG. 5 illustrates a schematic diagram of an example computational storage device.

FIG. 6A illustrates flowchart of an example process of executing one or more programs based on an execute program command.

FIG. 6B illustrates a block diagram of an example process of executing one or more programs based on an execute program command.

FIG. 7 illustrates an example process of executing an execute program command.

### DETAILED DESCRIPTION

The present disclosure relates to managing program execution in a memory device. Some memory devices are configured to execute one program at a time according to a command in a non-volatile memory express (NVMe) command set. In some cases, a host needs to receive the complete status of a previous program before sending the next program to a computational storage device for execution. The process of communicating between the host and the computational storage device can be time-consuming and less efficient when the computational storage device needs to execute multiple programs.

In some implementations, a system can include a host configured to send an execute program command, which indicates one or multiple programs and an order of executing the multiple programs when the multiple programs are indicated in the NVMe command set. The system can include a computational storage device. The computational storage device is configured to receive the execute program command from the host, and in response to determining that the execute program command indicates multiple programs, execute the multiple programs according to the order of executing the multiple programs.

Implementations of the present disclosure can provide one or more of the following technical advantages and/or benefits. For example, the execute command sent by the host can include a flag indicating whether one or multiple programs are to be executed by the computational storage device. A value of the flag equal to 1 indicates that multiple programs need to be executed, and the execute program command can include a mapping table. The mapping table includes the order of executing the multiple programs and dependencies of each program. The computational storage device receives the execute command, executes the multiple programs according to the order of executing the multiple programs and dependencies of each program, and only sends one command status to the host after completion of execution of the multiple programs, which reduces communication between the host and the computational storage device. In other words, the implementations of the present disclosure can reduce execution time and improve efficiency when executing multiple programs. The above aspects and some other aspects of the present disclosure are discussed in greater detail below.

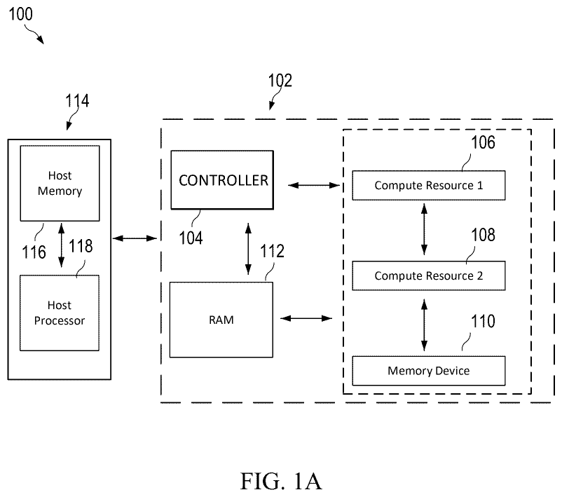

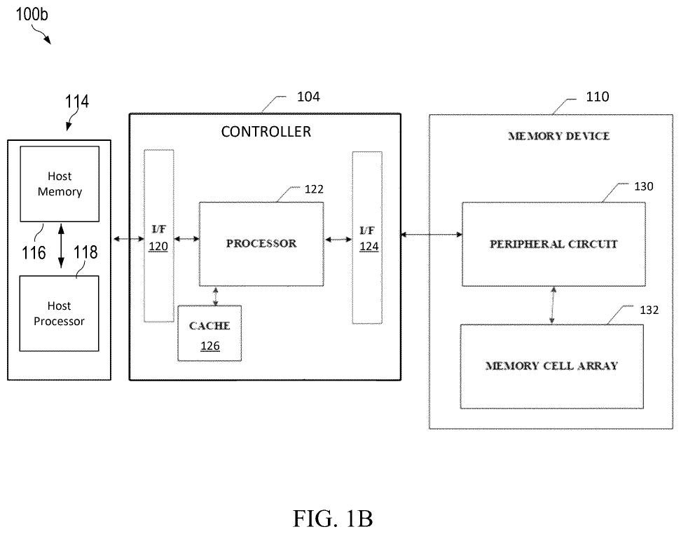

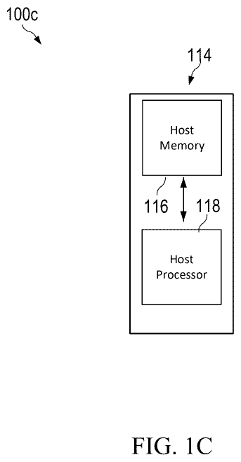

FIG. 1A illustrates a block diagram of an example system 100 having a memory device, according to some aspects of the present disclosure. The example system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1A, the example system 100 can include a host 114 and a computational storage device 102. The host 114 can include a host memory 116 and a host processor 118. The computational storage device 102 can include a controller 104, a random access memory (RAM) 112, one or more computational resources 106, 108, and memory device 110. The host 114 can include one or more host processors 118 of an electronic device. The host processor 118 can be a central processing unit (CPU), or a system-on-chip (SoC), such as an application processor (AP). The host 114 can be configured to send or receive data and commands to or from the computational storage device 102. In some implementations, the host memory 116 or a part of the host memory 116 can be used as a data buffer that is pointed by a data pointer of an execute program command.

The memory device 110 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random-access memory (MRAM), Spin-transfer torque magnetic random-access memory (STT-RAM), or Resistive random-access memory (RRAM), etc. In some implementations, memory device 110 includes a three-dimensional (3D) NAND Flash memory device.

The controller 104 can be implemented by microprocessors, microcontrollers (a.k. a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail. In some implementations, the computational resources 106 and 108 can be implemented by application-specific integrated circuits (ASICs), filed-programmable gate arrays (FPGA, programmable logic devices (PLDs), and other suitable hardware, firmware, and/or software configured to perform the various functions described below in detail. In some implementations, the controller 104 is operating under a non-volatile memory express (NVMe) command set.

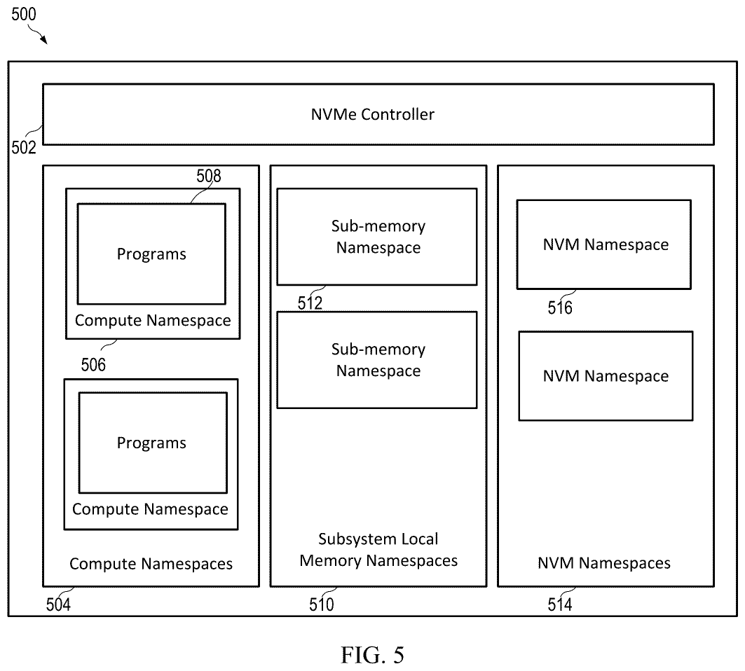

The controller 104 is coupled to the computational resources 106, 108, the RAM 112 and to the host 114, and is configured to control the computational resources 106, 108, according to some implementations. The controller 104 can receive and parse an execute program command from a host, send the parsed execute program command to the computational resources 106, 108 to execute the program and can communicate with the host 114. In some implementations, the execute program command is in a non-volatile memory express (NVMe) command set. In some implementations, the controller 104 is designed for operating in a in a high duty-cycle environment solid state drives (SSDs) or embedded multi-media-cards (eMMCs) used as data storage for mobile devices, such as smartphones, tablets, laptop computers, etc., and enterprise storage arrays follows the NVMe command set. In some implementations, the controller 104 is configured to follow a non-volatile memory express over Fabrics (NVMe-oF) command set. The computational resources 106 and 108 are coupled to the controller 104 and the RAM 112. In some implementations, the computational resources 106 and 108 can access the RAM 112 and the controller 104 can access the RAM 112. The controller 104 is can also be configured to control operations of the memory device 110, such as read, erase, and write operations. The computational resources 106 and 108 can be configured to execute a program based on the parsed execute program command sent by the controller 104. In some implementations, the computational resources 106 and 108 can be defined as compute namespaces (the compute namespace 506 in FIG. 5) and can be implemented by application-specific integrated circuits (ASICs), filed-programmable gate arrays (FPGA, programmable logic devices (PLDs), and other suitable hardware.

The controller 104 can communicate with an external device (e.g., the host 114) according to a particular communication protocol. In some implementations, the communication protocol follows a non-volatile memory express (NVMe) command set. In some implementations, the communication protocol follows a non-volatile memory express over Fabrics (NVMe-oF) command set. For example, the controller 104 can communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The controller 104 is configured to receive and transmit an execute program command to and from the host 114, parse the received execute program command from the host 114, and send the parsed execute program command to the computational resources 106 and 108 to perform multiple functions and operations provided in the present disclosure. In some implementations, the execute program command can include multiple programs with an order of executing the multiple programs. The computational storage device 102 is configured to execute the multiple programs according to the order of executing the multiple programs, in response of determining that the execute program command indicates multiple programs. In some implementations, the execute program command can include one program to be executed by the computational storage device 102. The computational storage device 102 is configured to execute the one program in response of determining that the execute program command indicates one program. In some implementations, the controller 104 is coupled to the memory device 110 and is configured to receive and execute the commands from the host 114. In one example, as shown in FIG. 1B, illustrates a block diagram of an example system 100b having the controller 104 coupled to the memory device 110.

As shown in FIG. 1B, the controller 104 can include a first interface 120 coupled to the host 114. The first interface 120 is configured to communicate with the host 114. In some implementations, the first interface is configured to receive the commands from the host 114 and send a command status to the host 114 after completion of execution of the multiple programs. The first interface 120 is coupled to a processor 122 of the controller 104. The processor 122 of the controller 104 is configured to parse the received command from the host 114 and send the parsed command to the memory device 110 for execution through a second interface 124. The controller 104 can include a cache 126 coupled to the processor 122. In some implementations, the controller 104 can include the computational resources 106 and 108. In some implementations, the computational resources 106 and 108 are coupled to the controller 104, where the controller 104 is configured to control the computational resources 106 and 108. The memory device 110 can include a peripheral circuit 130 coupled to a memory cell array 132.

In some implementations (not shown in FIGS. 1A to 1B), the peripheral circuits 130 can be coupled to the memory cell array through bit lines, word lines, SLs, SSG lines, and DSG lines. The peripheral circuits 130 can include any suitable analog, digital, and mixed-signal circuits for facilitating the operations of the memory cell array 132 by applying and sensing voltage signals and/or current signals to and from each target memory cell through bit lines, word lines, SLs, SSG lines, and DSG lines. The peripheral circuits 130 can include various types of peripheral circuits formed using metal-oxide-semiconductor (MOS) technologies.

FIG. 1C illustrates a block diagram of an example host 100c, according to some aspects of the present disclosure. The host 114 can include one or more host processors 118 of an electronic device. The host processor 118 can be a central processing unit (CPU), or a system-on-chip (SoC), such as an application processor (AP). The host 114 can be configured to send or receive data and commands to or from the computational storage device 102. In some implementations, the host memory 116 or a part of the host memory 116 can be used as a data buffer that is pointed by a data pointer of an execute program command.

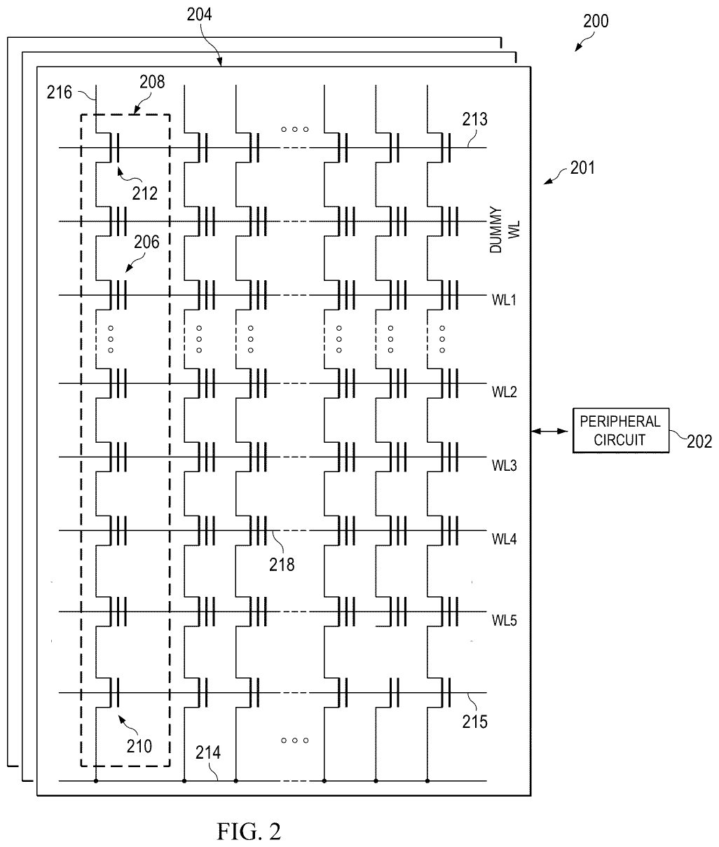

FIG. 2 illustrates a schematic diagram of an example memory device 200 including peripheral circuits, according to some aspects of the present disclosure. In some implementations, the memory device 200 can be the memory device 110 of the example system 100b of FIG. 1B. The memory device 200 can include a memory cell array 201 and peripheral circuits 202 coupled to the memory cell array 201. The memory cell array 201 can be a NAND flash memory cell array in which memory cells 206 are provided in the form of an array of NAND memory strings 208 each extending vertically above a substrate (not shown in FIG. 2). In some implementations, each NAND memory string 208 includes a plurality of memory cells 206 coupled in series and stacked vertically. Each memory cell 206 can hold a continuous, analog value, such as an electrical voltage or charge that depends on the number of electrons trapped within a storage layer of the memory cell 206. The logic state (i.e., data) of each memory cell 206 in a memory block 204 can be determined based on the threshold voltage Vth of the memory cell 206. Each memory cell 206 can be a floating gate type memory cell including a floating-gate transistor, or a charge trap type memory cell including a charge-trap transistor. In some implementations, the peripheral circuits 202 can be similar to, or same as the peripheral circuits 132 of the example system 100b of FIG. 1B.

In some implementations, each memory cell 206 is a single-level cell (SLC) with two possible memory states that can store one bit of data. For example, the first memory state “0” can correspond to a first range of voltages, and the second memory state “1” can correspond to a second range of voltages. In some implementations, each memory cell 206 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 2, each NAND memory string 208 can include a source select gate (SSG) 210 at its source end and a drain select gate (DSG) 212 at its drain end. The SSG 210 and the DSG 212 can be configured to activate selected NAND memory strings 208 (columns of the array) during read and program operations. In some implementations, the sources of NAND memory strings 308 in the same memory block 204 are coupled through a same source line (SL) 214, e.g., a common SL. In other words, NAND memory strings 208 in the same memory block 204 have an array common source (ACS), according to some implementations. The DSG 212 of each NAND memory string 208 is coupled to a respective bit line 216 from which data can be read or written via an output bus (not shown), according to some implementations. In some implementations, each NAND memory string 308 is configured to be selected or deselected by applying a select voltage (e.g., above the threshold voltage of the transistor having the DSG 212) or a deselect voltage (e.g., 0 V) to the respective DSG 212 through one or more DSG lines 213, and/or by applying a select voltage (e.g., above the threshold voltage of the transistor having the SSG 310) or a deselect voltage (e.g., 0 V) to the respective SSG 210 through one or more SSG lines 215.

As shown in FIG. 2, NAND memory strings 208 can be organized into multiple memory blocks 204, each of which can have a common SL 214 coupled to the ACS. In some implementations, each memory block 204 can serve as a basic data unit for erase operations, such that memory cells 206 on the same memory block 204 are erased at the same time. To erase memory cells 206 in a selected memory block 204, the SL 214 coupled to the selected memory block 204 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 206 of adjacent NAND memory strings 208 can be coupled through word lines 218. The word line 218 can select which row of memory cells 206 is affected by read and program operations. Each word line 218 can include a gate line coupled to a plurality of control gates (gate electrodes) of a plurality of memory cells 206. Example word lines shown in FIG. 2 are between one or more DSG lines 213 and one or more SSG lines 215.

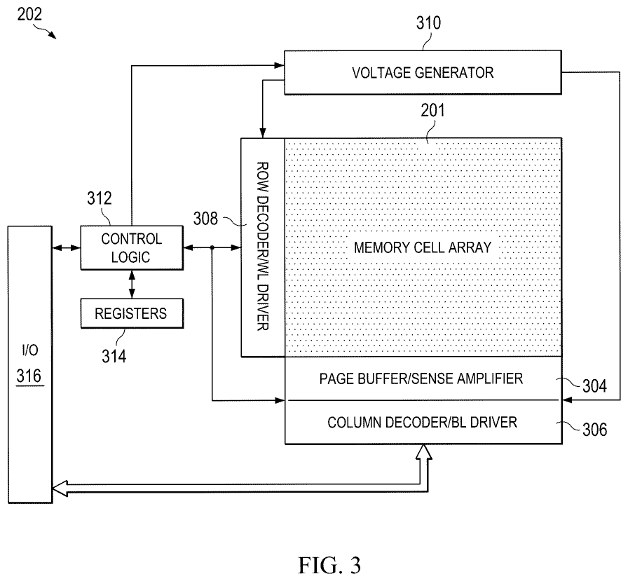

FIG. 3 illustrates some example peripheral circuits 202, according to some aspects of the present disclosure. In some implementations, the peripheral circuits 202 can be similar to, or same as the peripheral circuits 130 of the example system 100b of FIG. 1B. The peripheral circuits 202 can be coupled to the memory cell array 201 through bit lines 216, word lines 218, SLs 214, SSG lines 215, and DSG lines 213. The peripheral circuits 202 can include any suitable analog, digital, and mixed-signal circuits for facilitating the operations of the memory cell array 201 by applying and sensing voltage signals and/or current signals to and from each target memory cell 206 through bit lines 216, word lines 218, SLs 214, SSG lines 215, and DSG lines 213. The peripheral circuits 202 can include various types of peripheral circuits formed using metal-oxide-semiconductor (MOS) technologies. The example peripheral circuits 202 include a page buffer/sense amplifier 304, a column decoder/bit line driver 306, a row decoder/word line driver 308, a voltage generator 310, control logic 312, registers 314, an input/output (I/O) interface 316, and a data bus. In some examples, additional peripheral circuits not shown in FIG. 3 may be included as well.

The page buffer/sense amplifier 304 can be configured to read and program (write) data from and to memory cell array 201 according to the control signals from control logic 312. In another example, the page buffer/sense amplifier 304 may perform program verify operations to ensure that the data have been properly programmed into memory cells 206 coupled to selected word lines 218. In still another example, the page buffer/sense amplifier 304 may also sense the low power signals from the bit line 216 that represents a data bit stored in memory cell 206, and amplify the small voltage swing to recognizable logic levels in a read operation. The column decoder/bit line driver 306 can be configured to be controlled by the control logic 312 and select one or more NAND memory strings 208 by applying bit line voltages generated from the voltage generator 310.

The row decoder/word line driver 308 can be configured to be controlled by the control logic 312 and select/deselect memory blocks 204 of the memory cell array 201 and select/deselect word lines of the memory block 204. The row decoder/word line driver 308 can be further configured to drive word lines using word line voltages generated from the voltage generator 310. In some implementations, the row decoder/word line driver 308 can also select/deselect and drive SSG lines 215 and DSG lines 213. As described below in detail, the row decoder/word line driver 308 is configured to apply a program voltage to selected word line 218 in a program operation on memory cell 206 coupled to selected word line 218.

The voltage generator 310 can be configured to be controlled by the control logic 312 and generate the word line voltages (e.g., read voltage, program voltage, pass voltage, local voltage, verify voltage, etc.), bit line voltages, and source line voltages to be supplied to the memory cell array 201.

The control logic 312 can be coupled to each peripheral circuit described above and configured to control operations of each peripheral circuit. The registers 314 can be coupled to the control logic 312 and include status registers, command registers, and address registers for storing status information, command operation codes (OP codes), and command addresses for controlling the operations of each peripheral circuit.

The I/O interface 316 can be coupled to the control logic 312 and act as a control buffer to buffer and relay control commands received from a controller to the control logic 312 and status information received from the control logic 312 to the controller. The I/O interface 316 can also be coupled to the column decoder/bit line driver 306 via a data bus, and act as a data input/output (I/O) interface and a data buffer to buffer and relay data to and from the memory cell array 201.

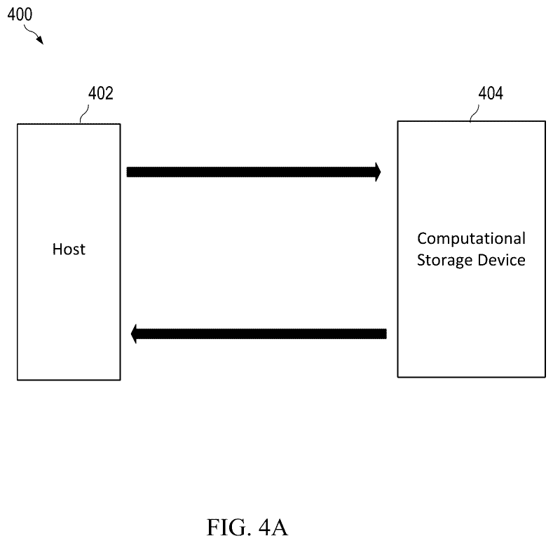

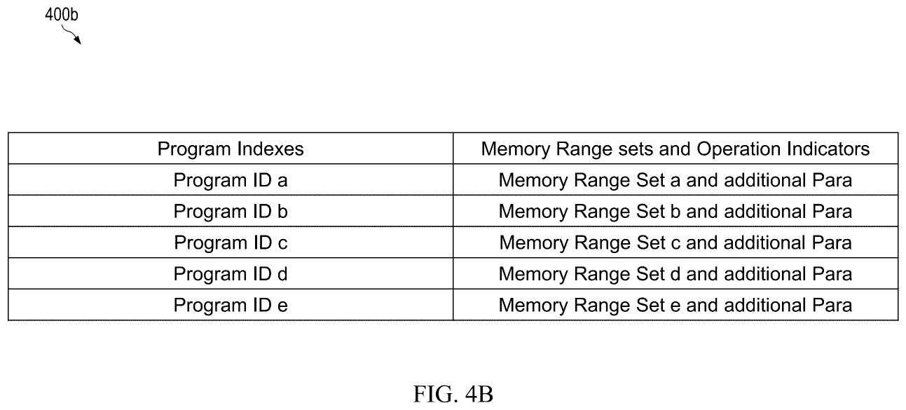

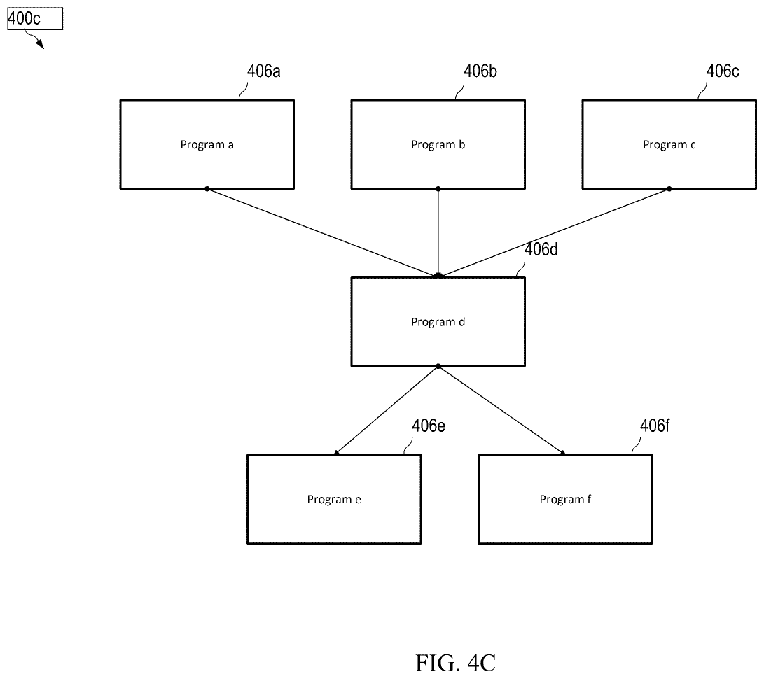

FIG. 4A illustrates a diagram of an example process 400 of executing a command, according to some aspects of the present disclosure. In some implementations, the command executed by the process 400 can be an execute program command. The host 402 is configured to send an execute program command to a computational storage device 404. In some implementations, the execute program command includes a flag that indicates whether one or multiple programs are to be executed. In some implementations, a value of the flag equals to 0 indicating that one program is to be executed by the computational storage device 404. The computational storage device 404 is configured to execute the one program and send a command status to the host 402 after completion of execution of the one program. The command status is a success status corresponding to the execution of the one program being successful or a failed status corresponding to the execution of the one program being failed. In some implementations, a value of the flag equals to 1 indicating that multiple programs are to be executed by the computational storage device 404. The execute program command will include a mapping table (as shown if FIG. 4B) indicating an order of executing the multiple programs. In some implementations, the mapping table is included in the execute program command. In some implementations, the mapping table is stored in a data buffer and the execute program command includes a data pointer identifying an address of the mapping table in the data buffer. In some implementations, the data buffer is stored in the host memory (e.g., the host memory 116 of FIG. 1A). The computational storage device 404 is configured to execute the multiple programs according to the order of executing the multiple programs and send a command status to the host 402 after completion of execution of the multiple programs. The command status is a success status corresponding to the execution of the multiple programs being successful or a failed status corresponding to the execution of the multiple programs being failed. In some implementations, the failed status can include one or more indices corresponding to one or more of the multiple programs being failed.

In some implementations, the execute program command can include a number of memory ranges (NUMR) identifying a quantity of memory ranges in the data buffer. In some implementations, the execute program command can include the data pointer (DPTR) identifying a location of the mapping table in the data buffer. In some implementations, the execute program command can include a data pointer data length (DLEN) identifying a length of the DPRT. In some implementations, the execute program command can include parameter data to be passed in a command entry.

FIG. 4B illustrates an example mapping table 400b according to some aspects of the present disclosure. The mapping table 400b can include one or more program to be executed by the computational device 404. In some implementations, the mapping table 400b can include program indexes and execution sequence of the multiple programs to be executed by the computational storage device 404, operation indicators identifying memory range sets of the multiple programs within the computational storage device 404, and parameters identifying an address of input and output parameters in the memory range sets. In some implementations, as shown in FIG. 4B, the order of executing the multiple programs indicated by the mapping table 400b can be in a sequential order, where a first output of a first program feeds into a first input of a second program. In some implementations (not shown in FIG. 4B), the order of executing the multiple programs indicated by the mapping table 400b can be in a parallel execution order, where the multiple programs are executed at the same time by the computational storage device 404. In some implementations, as shown in FIG. 4C, the order of executing the multiple programs indicated by the mapping table 400b can be a combination of the parallel execution order and the sequential execution order. The computational storage device 404 is configured to execute a first portion of the multiple programs in the parallel execution order and generate an output. The computational storage device 404 is configured to feed the output of the first portion of the multiple programs and an input of a second portion of the multiple programs. In some implementations, the host 402 is similar to, or same as, the host 114 of the example system 100 of FIG. 1A. In some implementations, the computational storage device 404 is similar to, or same as the computational storage device 102 of the example system 100 of FIG. 1A.

FIG. 4C illustrates an example order of operation 400c of an execute program command according to some aspects of the present disclosure. In some implementations, as shown in FIG. 4C, the mapping table can include the program IDs, input and output parameter address, and the memory range set associated to each program. As shown in FIG. 4C, the programs 406a, 406b, and 406c are executed by the compute namespace in parallel, where the outputs of the programs 406a, 406b, and 406c are used as the inputs of the program 406d. The program 406d is executed by the compute namespace after successful execution of the programs 406a, 406b, and 406c. The output of the program 406d can be used as the input for programs 406e and 406f, where the programs 406e and 406f are executed after successful execution of the program 406d. In some implementations, the computational storage device is configured to send a command status to the host 402 after completion of execution of the multiple programs according to the example order of operation 400c. The command status is a success status corresponding to the execution of the multiple programs being successful or a failed status corresponding to the execution of the multiple programs being failed. In some implementations, the failed status can include one or more indices corresponding to one or more of the multiple programs being failed.

FIG. 5 illustrates a schematic diagram of an example computational storage device 500, according to some aspects of the present disclosure. The example computational storage device 500 can be a part of the example system 100 of FIG. 1A.

The computational storage device 500 can include a non-volatile memory express (NVMe) controller 502. In some implementations, the NVMe controller 502 can be similar to, or as a part of the controller 104 of the example system 100 of FIG. 1A. The NVMe controller 502 is configured to receive and parse an execute program command from a host. The NVMe controller 502 is coupled to compute namespaces 504. The compute namespaces 504 can include one or more compute namespace 506, and each compute namespace 506 be configured to operate one or more programs 508. The compute namespace 506 is configured to receive the parsed execute program command from the NVMe controller 502 and execute the multiple programs 508 based on the parsed execute program command. In some implementations, the compute namespace 506 can include computational resources similar to, or same as the computational resources 106, 108 of the example system 100 of FIG. 1A. The computational storage device 500 can include a first memory namespace 510. In some implementations, the first memory namespace 510 can be a subsystem local memory namespaces. In some implementations, the first memory namespace 510 can include one or more sub-memory namespace 512. Each sub-memory namespace 512 can be managed for storing input and/or output parameters for the one or more programs. In some implementations, the sub-memory namespace 512 can implemented by the RAM 112 of the example system 100 of FIG. 1A and/or the cache 126 of the controller 104 of FIG. 1B. The computational storage device 500 can include a second memory namespace 514. In some implementations, the second memory namespace 514 can be a non-volatile memory (NVM) namespace. In some implementations, each second memory namespace 514 can include one or more NVM namespace 516. The NVM namespace 516 can include memory data. In some implementations, the NVM namespace 516 can be similar to, or same as the memory device 110 of the example system 100 of FIG. 1A or the memory cell array 132 of the example system 100b of FIG. 1B. In some implementations, the compute namespace 506 is coupled to the first memory namespace 510 and configured to perform program operation on the input and output parameters of the sub-memory namespace 512 of the first memory namespace 510. In some implementations, the first memory namespace 510 is coupled to the second memory namespace 514 and configured to copy and write memory data to the NVM namespace 516 of the second memory namespace 514.

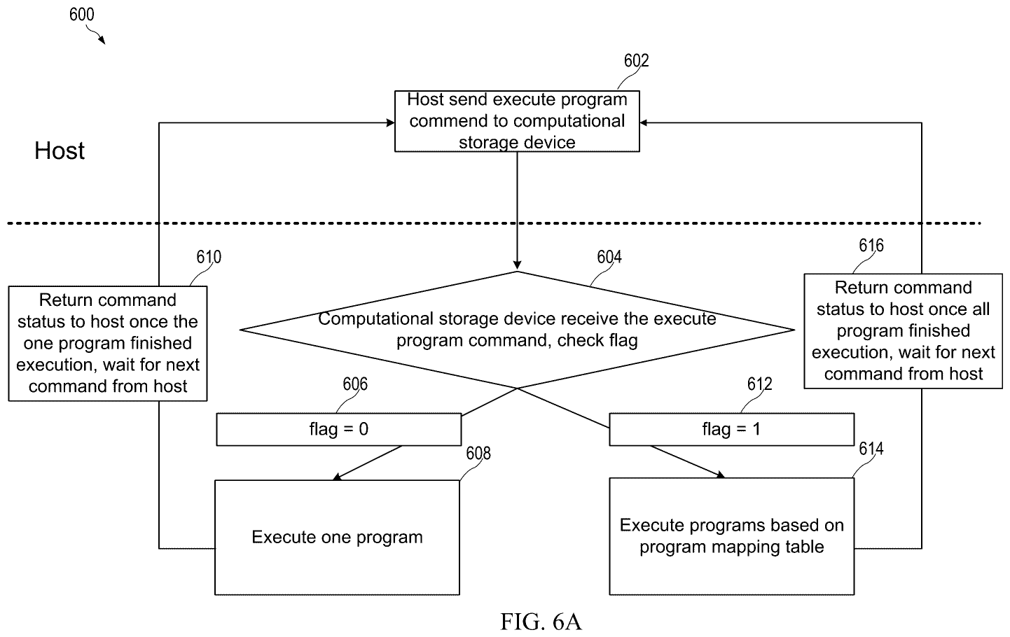

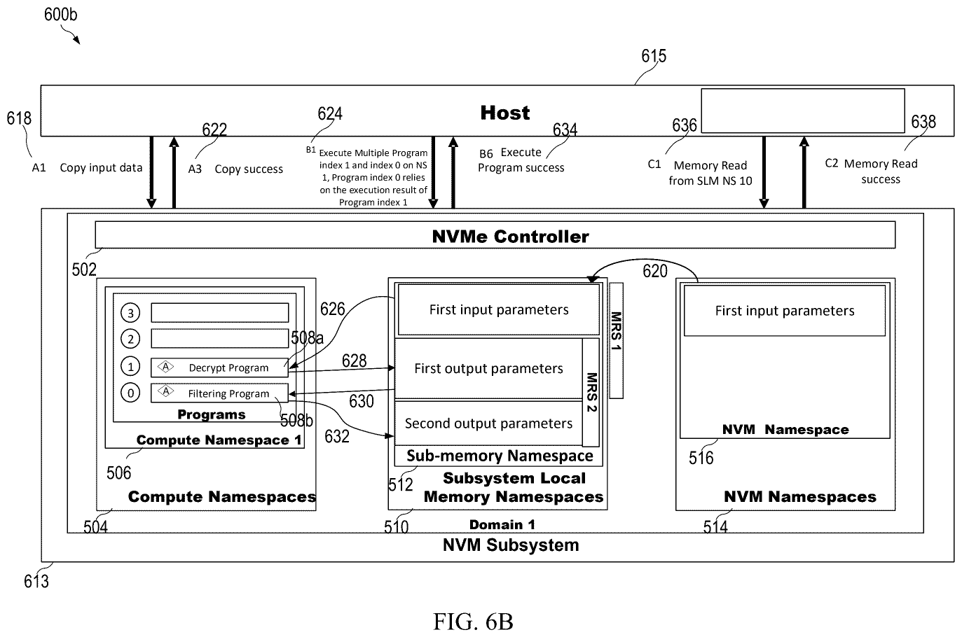

FIG. 6A is a flowchart of an example process 600 of executing one or more programs based on an execute program command, in accordance with some aspects of the present disclosure. The operations shown in the process 600 may not be exhaustive and other operations can be performed as well before, after, or between any of the illustrated operations. In some implementations (not shown in the flow chart), the process includes loading one or more programs (e.g., the programs 508 of FIG. 5) to a compute namespace (e.g., the compute namespace 506 of FIG. 5), creating memory range sets according the one or more programs to a memory namespace (e.g., the sub-memory namespace 512 of FIG. 5), and activating the one or more programs in the compute namespace. In some implementations, the process 600 can be performed by a system (the example system 100 of FIG. 1A) that includes a host and a computational storage device (e.g., the computational storage device 102 of FIG. 1A or the computational storage device 500 of FIG. 5). Some or all of the operations in the process 600 can be implemented based on the techniques described in connection with FIG. 5.

In some implementations, before the process 600, a host (e.g., the host 114 of FIG. 1A) sends a confirmation command to a computational storage device (e.g., the computational storage device 102 of FIG. 1A) to check whether a compute namespace (e.g., the compute namespace 506 of FIG. 5) of the computational storage device can support operating multiple programs with one execute program command. In some implementations, the computational storage device sends the confirmation back to the host device to verify whether the compute namespace of the computational storage device can support operating multiple programs with one execute program command.

At operation 602, the host sends execute program command to the computational storage device based on a requirement of executing one or more programs. The execute program command includes a flag. In some implementations, a value of the flag is set to 0 indicating only one program that needs to be executed by the computational storage device. The host sends the execute program command with the value of the flag set to 0 in the command format to the computational storage device. In some implementations, the value of the flag is set to 1 indication multiple programs that need to be executed by the computational storage device. The host sends the execute program command with the value of the flag set to 1 in the command format to the computational storage device. The execute command also includes a mapping table (e.g., the mapping table 400b of FIG. 4B) that indicates an order of executing the multiple programs and dependencies of each program, when the multiple programs are indicated, to the computational storage device.

At operation 604, the execute program command is received and parsed by a controller (e.g., the controller 104 of FIGS. 1A-1B or the NVMe controller 502 of FIG. 5) of the computational storage device. A processor (e.g., the processor 122 of FIG. 1B) of the controller checks the flag of the execute program command.

At operation 606, the value of the flag is 0 indicating that one program is to be executed. In some implementations, the controller sends the parsed execute program command indicates a program index of the one program to be executed to a compute namespace (the compute namespace 506 of FIG. 5) to execute the one program (the program 508 of FIG. 5). In some implementations, the controller executes the program with the processor of the controller.

At operation 608, the compute namespace executes the one program.

At operation 610, the computational storage device sends command status to the host through the controller once the one program finished execution and waits for next command from host.

At operation 612, the value of the flag is 1 indicating that multiple programs are to be executed. The processor of the controller locates the mapping table and parses the order of executing the multiple programs and the dependencies of each program based on the mapping table. In some implementations, the controller sends the parsed execute program command, the order of executing the multiple programs and the dependencies of each program to the compute namespace to execute the multiple programs. In some implementations, the controller and/or the computational resources execute the multiple programs based on the order of executing the multiple programs and the dependencies of each program with the processor of the controller.

At operation 614, the compute namespace executes the multiple programs according to the order of executing the multiple programs and the dependencies of each program.

At operation 616, the computational storage device sends command status to the host through the controller once the multiple programs finished execution and waits for next command from host.

FIG. 6B illustrates a block diagram 600b of an example process of executing one or more programs based on an execute program command, according to some aspects of the present disclosure. In some implementations, as shown in FIG. 6B, the one or more programs 508 include two programs 508a and 508b to be executed by the compute namespace 506, where an output parameter of the program 508a is used as an input parameter of the program 508b. For example, as shown in FIG. 6B, the program 508a can be a decrypt program and the program 508b can be a filtering program, where the decrypt program 508a decrypts input data/the input parameter to a list and the filtering program 508b filters the list decrypted by the program 508a to show specific data.

At operation 618, a host 615 sends a copy command to the computational storage device 613 to copy input parameter to the sub-memory namespace 512 of a first memory namespace 510 from a NVM namespace 516 of second memory namespaces 514. In some implementations, the input parameter is used by a program to perform operations. In some implementations, the input parameter is stored in a first data buffer in the host 615 pointed by a data pointer of the copy command and the computational storage device 613 copies the input parameter from the first data buffer based on the address provided by the data pointer directly to the sub-memory namespace 512 of a first memory namespace 510.

At operation 620, in response to the copy command sent by the host device, the controller 502 of the computational storage device 613 copies the input data from the NVM namespace 516 of the second memory namespaces 514 to the sub-memory namespace 512 of the first memory namespace 510.

At operation 622, the controller 502 of the computational storage device 613 sends a success command status to the host 615 to confirm the computational storage device successfully executed the copy command.

At operation 624, the host 615 sends execute program command to the computational storage device 613 based on a requirement of executing one or more programs. In some implementations, as shown in operation 624, the execute command includes a data pointer that point to a second data buffer in the host 615. In some implementations, the second data buffer can include a mapping table, such as the mapping table 400b shown in FIG. 4B. For example, the mapping table includes the program indexes for programs 508a and 508b, parameters identifying addresses for an input parameter and output parameter of each program in a memory range set, and the order of execution for programs 508a and 508b. The execute program command is received and parsed by a controller 502 of the computational storage device 613. The controller 502 sends the parsed execute program command to the compute namespace 506 for program execution based on the order provided by the mapping table. For example, as shown in FIG. 6B, the compute namespace 506 of the computational storage device 613 executes the program 508a before the program 508b.

At operation 626, the compute namespace 506 locates the input parameter of the program 508a. The input parameter of the program 508a is indicated by the address for the input parameter of the program 508a in the mapping table. For example, as shown in FIG. 6B, the program 508 a is a decrypt program. The compute namespace 506 locates the input parameter copied to the sub-memory namespace 512 in the operation 620 according to the address of the input parameter in the mapping table.

At operation 628, the compute namespace 506 generates first output parameters by executing the program 508a and stores the first output parameters in the sub-memory namespace 512 according to the address of the first output parameters in the mapping table. In some implementations, the address of the first input parameters in the sub-memory namespace 512 is different compared to the address of the first output parameter in the sub-memory namespace 512. For example, as shown in FIG. 6B, the program 508a is the decrypt program. The compute namespace 506 decrypts the input parameter located in the operation 626 to generate first output parameters and stores the first output parameters to the sub-memory namespace 512 according to the address of the first output parameter in the mapping table. In some implementations, the address of the first input parameters in the sub-memory namespace 512 is different compared to the address of the first output parameter in the sub-memory namespace 512.

At operation 630, the compute namespace 506 locates input parameters of the program 508b according to the address of the input parameters of the program 508b in the mapping table, where the input parameters for the program 508b can be the first output parameters of the program 508a. For example, as shown in FIG. 6B, the program 508 a is a filtering program. The compute namespace 506 locates the first output parameters stored in the sub-memory namespace 512 in the operation 628 according to address in the mapping table.

At operation 632, the compute namespace 506 generates second output parameters by executing the program 508b and stores the second output parameters in the sub-memory namespace 512 according to the address of the second output parameters in the mapping table. In some implementations, the address of the first output parameters in the sub-memory namespace 512 is different compared to the address of the second output parameter in the sub-memory namespace 512. For example, as shown in FIG. 6B, the program 508b is the filtering program. The compute namespace 506 filters the first output parameters located in the operation 630 to generate second output parameters and stores the second output parameters to the sub-memory namespace 512 according to the address of the second output parameter in the mapping table. In some implementations, the address of the first output parameters in the sub-memory namespace 512 is different compared to the address of the second output parameter in the sub-memory namespace 512.

At operation 634, the controller 502 of the computational storage device 613 sends a success command status to the host 615 to confirm the computational storage device successfully executed the execute program command, that is, to confirm the computational storage device successfully executed the multiple programs based on the order directly or indirectly parsed from the execute program command. In some implementations, the computational storage device 613 only sends one success command status to the host 615 after completion of execution of the programs 508a and 508b. The one success command status reduces a number of communications between the host 615 and the computational storage device 613 when executes multiple programs, thus leads to a lower program execution time when executing multiple programs based on the mapping table.

At operation 636, the host 615 sends a memory read command to the computational storage device 613 to read the second output parameters stored in the sub-memory namespace 512 in operation 632.

At operation 638, in response to the memory read command sent by the host device, the controller 502 of the computational storage device 613 sends the second output parameters stored in the sub-memory namespace 512 to the host 615 based on the memory read command. It is understood that the second output parameters output from the computational storage device 613 can be stored in the host memory 116 as shown in FIG. 1C.

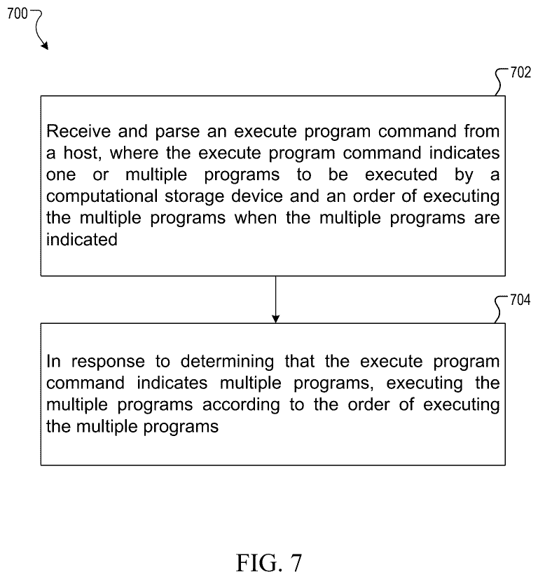

FIG. 7 illustrates an example process 700 of executing an execute program command, according to some aspects of the present disclosure. The process 700 can be performed to execute an execute program command (e.g., the diagram of an example process of executing an execute program command of FIG. 4A or the flowchart of an example process of executing one or more programs based on an execute program command of FIG. 6A). It is understood that the operations shown in process 700 are not exhaustive and that other operations can be performed as well before, after, or between any of the illustrated operations. Further, some of the operations may be performed simultaneously, or in a different order than shown in FIG. 7.

At operation 702, a computational storage device (e.g., the computational storage device 102 of FIG. 1A or the computational storage device 500 of FIG. 5) receives and parses an execute program command from a host (e.g., the host 114 of FIG. 1A), where the execute program command indicates one or multiple programs to be executed by a computational storage device and an order of executing the multiple programs when the multiple programs are indicated.

At operation 704, in response to determining that the execute program command indicates multiple programs, the computational storage device executes the multiple programs according to the order of executing the multiple programs.

In some implementations, the computational storage device is further configured to send a command status to the host after completion of execution of the multiple programs, where the command status is a success status corresponding to the execution of the multiple programs being successful or a failed status corresponding to the execution of the multiple programs being failed, where the failed status includes one or more indices corresponding to one or more of the multiple programs being failed.

In some implementations, the process further including: verifying a value of a flag of the execute program command (e.g., the value of the flag in operation 606 or the value of the flag in operation 612 of FIG. 6A), where the flag indicating whether one or multiple programs are to be executed.

In some implementations, the order of executing the multiple programs is indicated by a mapping table included in the execute program command or stored in a data buffer. In some implementations, the order of executing the multiple programs can be either directly indicated by the execute program command or indirectly indicated by the execute program command as well as a data buffer associated with the execute program command.

In some implementations, where the mapping table is stored in the data buffer, the process further including: identifying an address of the mapping table in the data buffer with a data pointer in the execute program command, and locating the mapping table in the data buffer based on the address.

In some implementations, the mapping table includes program indexes of the multiple programs to be executed by the computational storage device, operation indicators identifying memory range sets of the multiple programs within the computational storage device, and additional parameters identifying an address of input and output parameters in the memory range sets.

In some implementations, the order of executing the multiple programs is sequential, parallel, or a combination of sequential and parallel.

In some implementations, the computational storage device includes a controller (e.g., the controller 104 of FIGS. 1A-1B or the NVMe controller 502 of FIG. 5), and where the controller is configured to receive and parse the execute program command.

In some implementations, the computational storage device includes a compute namespace (e.g., the compute namespace 506 of FIG. 5) includes computational resources (e.g., the computational resources 106, 108 of FIG. 1A) configured to execute the multiple programs based on the parsed execute program command.

In some implementations, the computational storage device includes a subsystem local memory namespace (e.g., the subsystem local memory namespaces 510 of FIG. 5), where the subsystem local memory namespace stores input and output parameters for the multiple programs, and a non-volatile memory (NVM) namespace (e.g., the NVM namespaces 514 of FIG. 5), where the NVM namespace includes memory data.

In some implementations, execute the multiple programs including: executing the multiple programs on the compute namespace based on the memory range sets according to the order of executing the multiple programs.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A system, comprising:
a host configured to send an execute program command, wherein the execute program command indicates one or multiple programs and an order of executing the multiple programs when the multiple programs are indicated; and
a computational storage device configured to:
receive the execute program command from the host; and
in response to determining that the execute program command indicates multiple programs, execute the multiple programs according to the order of executing the multiple programs.

2. The system of claim 1, wherein the computational storage device is further configured to send a command status to the host after completion of execution of the multiple programs, wherein the command status is a success status corresponding to the execution of the multiple programs being successful or a failed status corresponding to the execution of the multiple programs being failed, wherein the failed status comprises one or more indices corresponding to one or more of the multiple programs being failed.

3. The system of claim 1, wherein the execute program command comprises a flag indicating whether one or multiple programs are to be executed.

4. The system of claim 1, wherein the order of executing the multiple programs is indicated by a mapping table comprised in the execute program command or stored in a data buffer.

5. The system of claim 4, wherein the mapping table is stored in the data buffer, the execute program command further comprises a data pointer identifying an address of the mapping table in the data buffer.

6. The system of claim 4, wherein the mapping table comprises program indexes of the multiple programs to be executed by the computational storage device, operation indicators identifying memory range sets of the multiple programs within the computational storage device, and parameters identifying an address of input and output parameters in the memory range sets.

7. The system of claim 4, wherein the order of executing the multiple programs is sequential, parallel, or a combination of sequential and parallel.

8. The system of claim 6, wherein the computational storage device comprises a controller, and wherein the controller is configured to:
receive and parsing the execute program command.

9. The system of claim 8, wherein the computational storage device further comprises:
a compute namespace, wherein the compute namespace is configured to execute the multiple programs based on the parsed execute program command;
a first memory namespace, wherein the first memory namespace input and output parameters for the multiple programs; and
a second memory namespace, wherein the second memory namespace comprises memory data.

10. The system of claim 9, wherein execute the multiple programs comprising:
executing the multiple programs on the compute namespace based on the memory range sets according to the order of executing the multiple programs.

11. A method, comprising:
receiving and parsing an execute program command from a host, wherein the execute program command indicates one or multiple programs to be executed by a computational storage device and an order of executing the multiple programs when the multiple programs are indicated; and
in response to determining that the execute program command indicates multiple programs, executing the multiple programs according to the order of executing the multiple programs.

12. The method of claim 11, wherein the computational storage device is further configured to send a command status to the host after completion of execution of the multiple programs, wherein the command status is a success status corresponding to the execution of the multiple programs being successful or a failed status corresponding to the execution of the multiple programs being failed, wherein the failed status comprises one or more indices corresponding to one or more of the multiple programs being failed.

13. The method of claim 11, further comprising:
verifying a value of a flag of the execute program command, wherein the flag indicates whether one or multiple programs are to be executed.

14. The method of claim 11, wherein the order of executing the multiple programs is indicated by a mapping table comprised in the execute program command or stored in a data buffer.

15. The method of claim 14, wherein the mapping table is stored in the data buffer, further comprising:
identifying an address of the mapping table in the data buffer with a data pointer in the execute program command; and
locating the mapping table in the data buffer based on the address.

16. The method of claim 14, wherein the mapping table comprises program indexes of the multiple programs to be executed by the computational storage device, operation indicators identifying memory range sets of the multiple programs within the computational storage device, and additional parameters identifying an address of input and output parameters in the memory range sets.

17. The method of claim 14, wherein the order of executing the multiple programs is sequential, parallel, or a combination of sequential and parallel.

18. The method of claim 16, wherein the computational storage device comprises:
a controller, and wherein the controller is configured to:
receive and parse the execute program command;
a compute namespace comprises computational resources configured to:
execute the multiple programs based on the parsed execute program command;
a first memory namespace, wherein the first memory namespace stores input and output parameters for the multiple programs; and
a second memory namespace, wherein the second memory namespace comprises memory data.

19. The method of claim 18, wherein execute the multiple programs comprising:
executing the multiple programs on the compute namespace based on the memory range sets according to the order of executing the multiple programs.

20. A computational storage device, comprising:
computational resources; and
a controller coupled to the computational resources and configured to control the computational resources,
wherein controller is configured to:
receive and parse an execute program command from a host, wherein the execute program command indicates one or multiple programs and an order of executing the multiple programs when the multiple programs are indicated, and
wherein the computational resources are configured to:
in response to determining that the execute program command indicates multiple programs, execute the multiple programs according to the order of executing the multiple programs.
